(19) United States
(12) Patent Application Publication
(10) Pub. No.: US 2008/0270475 A1
(43) Pub. Date: Oct. 30, 2008

(54) Data processing systems and methods for connecting business objects to data sources

(75) Inventor: Julien Delvat, Antibes Juan les Pins (FR)

Correspondence Address: SAP / FINNEGAN, HENDERSON LLP, 901 NEW YORK AVENUE, NW, WASHINGTON, DC, 20001-4413, US

(73) Assignee: SAP AG

(21) Appl. No.: 11/826,803

(22) Filed: Jul. 18, 2007

(30) Foreign Application Priority Data
Apr. 27, 2007 (EP) 07 290 527.6

(51) Int. Cl. G06F 17/30

(52) U.S. Cl. 707/104.1; 707/E17.009

(57) ABSTRACT

Systems and methods are provided for coupling business objects to data sources in a service-oriented architecture. The business objects may include a business object type from a plurality of business object types, and the data sources may be stored in quantity tables linked to a business object type. In one implementation, a system is provided that comprises a storage for storing a plurality of quantity tables, first processing means for performing a calculation on at least a specified business object type from the plurality of business object types, and second processing means for determining a first group of quantity tables linked to the specified business object type. The system may also include third processing means for selecting a data source from a first group of data sources stored in the first group of quantity tables, wherein the first processing means uses the selected data source in the calculation.

### TECHNICAL FIELD

The present invention relates generally to the field of data processing systems and methods. More particularly, and without limitation, the present invention relates to data processing systems and methods for connecting business objects to data sources.

### BACKGROUND

A service oriented architecture is a collection of data processing services. These services can communicate with each other. The communication can involve data processing and/or two or more services coordinating some activity or data processing task.

In a service oriented architecture, business objects are the building blocks of all applications. A business object is an entity which represents a concept, e.g., a cost center, a plant, or a business process. Business objects require connections to database tables and other business objects in order to get data, e.g., prices.

However, even in a service oriented architecture, data may not be stored in a business object; instead, data may be stored in a variety of sources. Therefore, it may be difficult to find the correct data. Even when data is stored in business objects, the source of the data has to be connected to the business object. Conventionally, this can be done using a specific program which deals with only one business object, which connects the source to a given set of tables or business objects. Using such a program, the addition of new data sources and the selection of data sources require modification of the program code.

### SUMMARY

Consistent with an embodiment of the present invention, a data processing system is provided for coupling business objects to data sources in a service oriented architecture. The system comprises a storage for storing a plurality of quantity tables; first processing means for performing a calculation on at least a specified business object type from the plurality of business object types; second processing means for determining a first group of quantity tables, the first group of quantity tables being the quantity tables linked to the specified business object type; and third processing means for selecting a data source from a first group of data sources, the first group of data sources being the data sources stored in the first group of quantity tables, wherein the first processing means uses the selected data source in the calculation.

Consistent with an embodiment of the present invention, the second processing means compares business keys of the specified business object with business keys of the quantity tables, and determines the first group of quantity tables as the quantity tables having business keys that match those of the specified business object type.

Consistent with an embodiment of the present invention, the data processing system further comprises a storage for storing a configuration table defining links between business object types and quantity tables. The second processing means determines the first group of quantity tables by reading the configuration table.

Consistent with an embodiment of the present invention, the data processing system further comprises a storage for storing at least one rule table containing restrictions on data sources to be used in the calculation. The second processing means may further determine a second group of quantity tables, the second group of quantity tables being those in the first group of quantity tables which match the restrictions specified in the rule table. The third processing means may further select a data source from a second group of data sources, the second group of data sources being those stored in the second group of quantity tables.

Consistent with an embodiment of the present invention, the rule table may contain a link to a restriction table which comprises further restrictions on the data sources to be used in the calculation.

Consistent with another embodiment of the present invention, a method is provided for selecting a data source for coupling to a business object for inclusion in a calculation. The method comprises determining a first group of quantity tables, the first group of quantity tables being those linked to the business object type. The method further comprises reading a first group of data sources, the first group of data sources comprising an item from each quantity table of the first group of quantity tables. The method further comprises selecting a data source from the first group of data sources for inclusion in the calculation.

Consistent with an embodiment of the present invention, the first group of quantity tables may be identified as those having business keys that match the business keys of the business object of the particular business object type.

Consistent with an embodiment of the present invention, the quantity tables linked to a business object type may be identified by reading a configuration table.

Consistent with an embodiment of the present invention, the first group of quantity tables may be determined by reading a configuration table and determining whether the configuration table contains a link for the business object. The first group of quantity tables is then determined from at least one of the configuration table if a link for the business object type exists, and the business keys if no link for the business object type exists.

Consistent with an embodiment of the present invention the method may further comprise reading a rule table containing restrictions on the data sources for use in the calculation, and determining a second group of data sources, the second group of data sources being the data sources in the first group of data sources that match the restrictions in the rule table. The data item selected for inclusion in the calculation is then selected from a second group of quantity tables.

Consistent with an embodiment of the present invention, the rule table may contain a plurality of rules. These rules may be applied in order of priority.

Consistent with an embodiment of the present invention, the rule table may contain an identifier of a restriction table. The restriction table may comprise restrictions on the data sources for use in the calculation.

Consistent with an embodiment of the present invention, the data source may be a price.

Consistent with an embodiment of the present invention, the calculation may be a preparation of a quote.

Consistent with an embodiment of the present invention, the method may be performed in a service oriented architecture.

Embodiments of the invention also encompass computer program products tangibly embodied in a compute-readable medium containing computer executable instructions to perform methods consistent with the present invention.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates a block diagram of an exemplary data processing system, consistent with an embodiment of the present invention;

FIG. 2 is a table of an exemplary object type, consistent with an embodiment of the present invention;

FIG. 3 is a table of an exemplary material object type, consistent with an embodiment of the present invention;

FIG. 4 is a table of an exemplary material price object type, consistent with an embodiment of the present invention;

FIG. 5 illustrates an exemplary method of linking an object type to a data source, consistent with an embodiment of the present invention;

FIG. 6 illustrates an exemplary data processing system, consistent with an embodiment of the present invention;

FIG. 7 illustrates an exemplary configuration table linking object types to data sources, consistent with an embodiment of the present invention;

FIG. 8 illustrates an exemplary rule table, consistent with an embodiment of the present invention;

FIG. 9 illustrates an exemplary rule table containing a link to another table, consistent with an embodiment of the present invention;

FIG. 10 is a flowchart of an exemplary method for selecting a data item for coupling to a business object for inclusion in a calculation, consistent with an embodiment of the present invention;

FIG. 11 is a flowchart of an exemplary method of performing a calculation, consistent with an embodiment of the present invention; and

FIG. 12 is a flowchart of an exemplary method of calculating a quote, consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations, and other implementations are possible, without departing from the spirit, and scope of the invention. For example, substitutions, additions, or modifications may be made to the components illustrated in the drawings, and the exemplary method described herein may be modified by substituting, reordering, or adding steps to the disclosed methods. Accordingly, the following detailed description does not limit the invention. Instead, the proper scope of the invention is defined by the appended claims.

Embodiments consistent with the invention may be implemented using conventional personal computers, desktops, hand held devices, multiprocessor computers, or the like.

The storage media referred to herein symbolize elements that temporarily or permanently store data and instructions. Although storage functions may be provided as part of a computer, memory functions can also be implemented in a network, processes, or elsewhere. Various types of storage mediums can be used to implement features of the invention such as read only memory, random access memory, or memory with other access options. Further, memory functions may be physically implemented by computer readable media, such as, for example magnetic media, like a hard disk, a floppy disk, a magnetic disk, a tape; optical media, like an optical disk such as a CD-ROM, or a digital versatile disk (DVD); semiconductor media, like DRAM, SRAM, EPROM, EEPROM, memory stick, and/or by any other media.

Embodiments consistent with the invention also encompass computer program products that are stored in a computer readable medium or transmitted using a carrier, such as an electronic carrier signal across a network between computers or other devices. In addition to transmitting carrier signals, network environments may be provided to link or connect components in the disclosed systems. Networking environments are commonplace in offices, enterprise wide computer networks, intranets and the internet. The network may be a wired or wireless network.

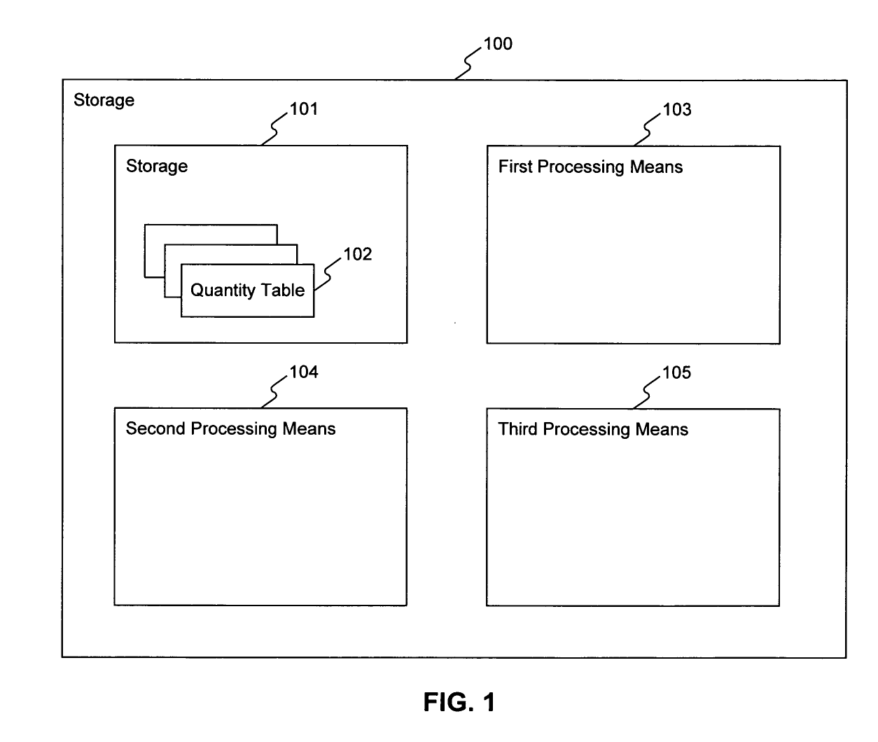

FIG. 1 illustrates a block diagram of an exemplary data processing system 100, consistent with an embodiment of the present invention. Data processing system 100 may be implemented in a service-oriented architecture. Data processing system 100 can be physically distributed over a number of computer systems that are interconnected by one or more networks. Furthermore, the various networked computer systems that constitute data processing system 100 can use a number of different operating systems and program languages. Alternatively, data processing system 100 can be implemented on a single computer. Data processing system 100 contains a storage 101 for storing a number of quantity tables 102. Data processing system 100 also includes first processing means 103 for performing a calculation on at least a specified business object type. Data processing system 100 further comprises second processing means 104 for determining a first group of quantity tables from quantity tables 102, wherein the first group of quantity tables is linked to the specified business object type. Data processing system 100 further comprises third processing means 105 for selecting a data source from the quantity tables 102 determined by second processing means 104.

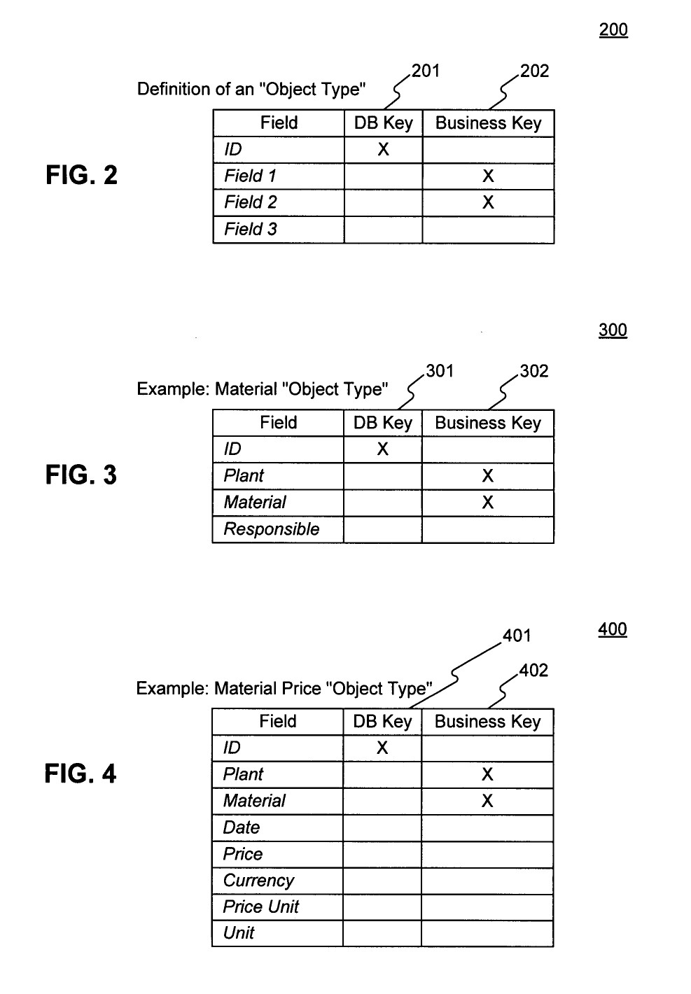

FIG. 2 illustrates a table of an exemplary object type, consistent with an embodiment of the present invention. A business object 200 can be represented as a table. A business object key may be used as a globally unique identifier. This identifier is absolutely unique. However, this identifier is not user friendly to deal with because it is an automatically generated 32-digit value. For this reason, business keys 202 are also provided so that the users can identify business objects 200 more easily. Business keys 202 are not changed once business object 200 is created, and only one business object exists per business key combination.

The linking of business object types to a data source is now described using the example of a material object type, as shown in FIG. 3, and a material price object type, as shown in FIG. 4. A material object type 300 has a database key 301 and business keys 302. The business keys in this example are plant and material. These business keys uniquely identify a particular material object type. The material price table 400 also has a database key 401 and business keys 402. When a calculation is performed on data processing system 100, third processing means 105 selects a data source, such as that shown in FIG. 4, to link to a business object, such as that shown in FIG. 3, for inclusion in the calculation carried out by first processing means 103.

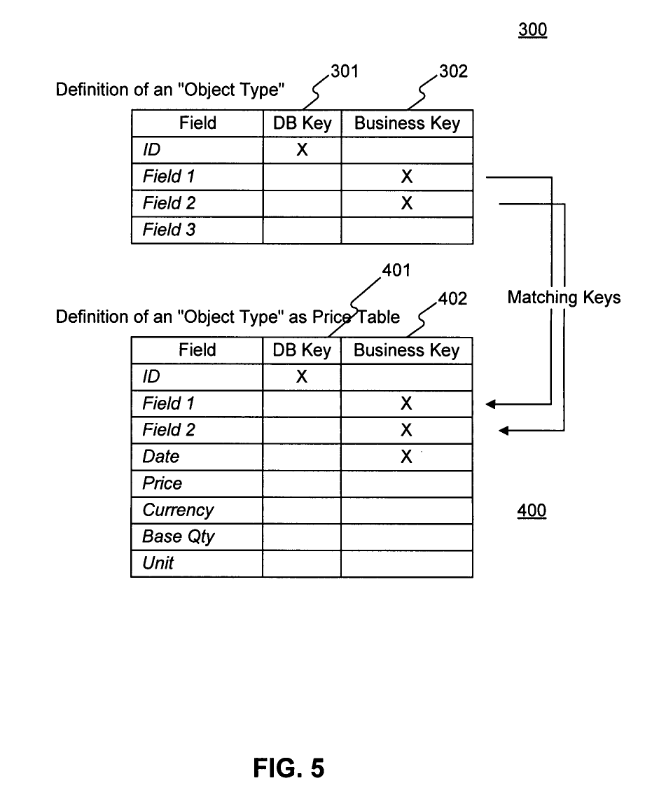

Consistent with an embodiment of the present invention, data source 400 for linking to object 300 may be selected using business key 302 of object 300. In order to determine a relevant data source for object 300, quantity tables 400 having business keys 402 which match those of object 300 can be determined by second processing means 104. An example of this method is illustrated in FIG. 5. Business keys 302 of business object 300 match business keys 402 of quantity table 400. Quantity table 400 may include additional business keys 402. Thus, there may be more than one quantity table 400 corresponding to a particular business object type 300. When performing a calculation in data processing system 100, third processing means 105 selects the data source from the relevant data sources selected by second processing means 104.

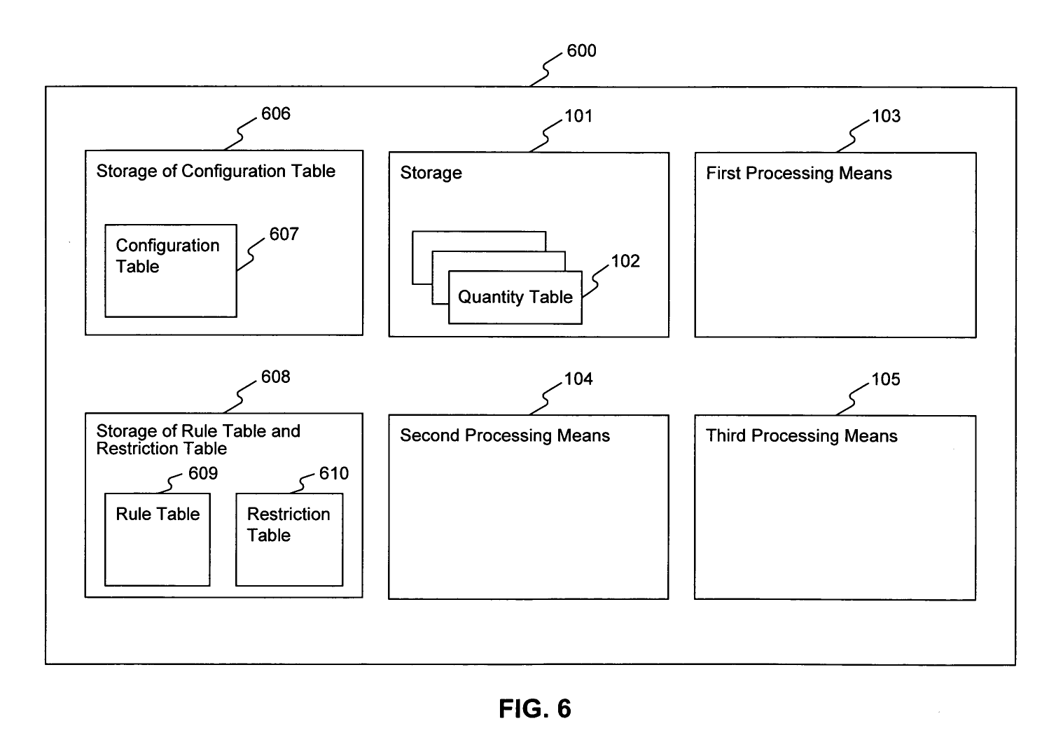

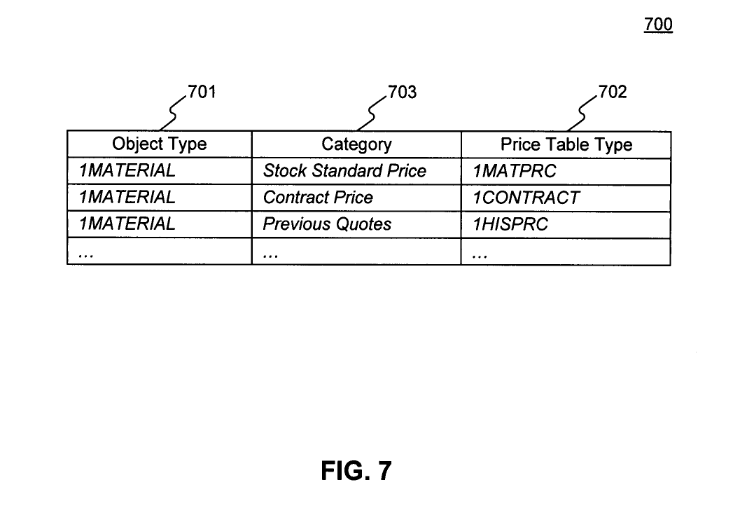

FIG. 6 illustrates an exemplary data processing system 600, consistent with an embodiment of the present invention. In addition to the features of data processing system 100 in FIG. 1, data processing system 600 in FIG. 6 includes an additional storage 606 for storing a configuration table 607. Data processing system 600 also includes a storage 608 for storing a rule table 609 and a restriction table 610. Configuration table 607 may be used to define links between object types and quantity tables. An example of a configuration table is shown in FIG. 7. Configuration table 700 contains links between object types 701 and quantity table types 702. Configuration table 700 further includes a category column 703 containing details of the links between the object types and the table types. Second processing means 104 may use configuration table 607 to determine the quantity tables linked to object types. Using configuration table 700 shown in FIG. 7, as an example, object types 701 are linked to price table types 702.

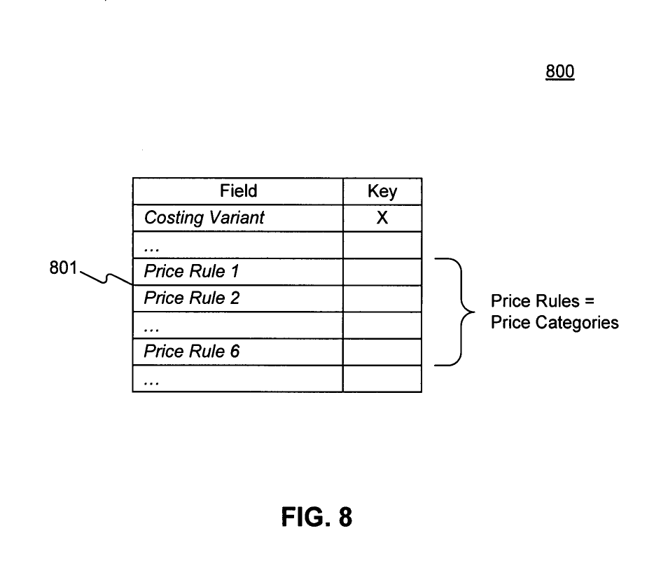

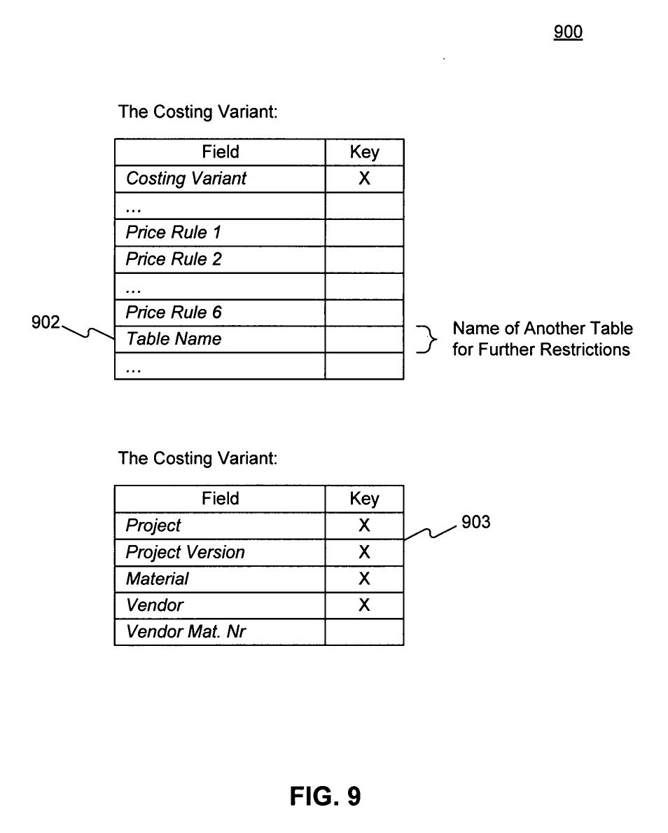

Storage 608 stores rule table 609 and restriction table 610. Rule table 609 may include a number of rules used by second processing means 104 to further restrict the quantity tables for use in the calculation. Rule table 609 may further include a link to restriction table 610 which can include further restrictions on the data sources to be used in the calculation. FIG. 8 illustrates an exemplary rule table, consistent with an embodiment of the present invention. Rule table 800 comprises a number of rules 801 which may contain further restrictions on the data sources to be used in the calculation. FIG. 9 illustrates an exemplary rule table 900 which, in addition to rules, contains a link 902 to a further restriction table 903. Restriction table 903 may contain further restrictions on the data sources to be used in the calculation.

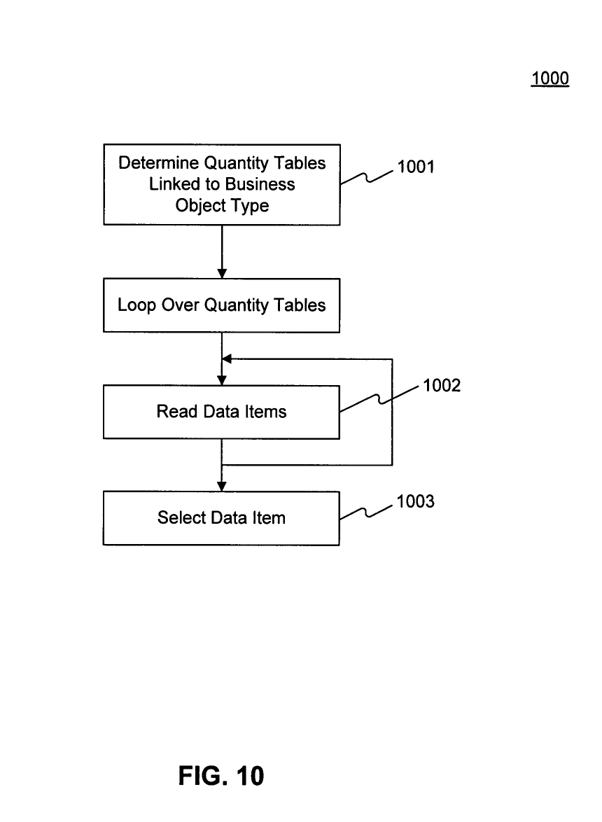

FIG. 10 is a flowchart of an exemplary method 1000 for selecting a data item for coupling to a business object for inclusion in a calculation, consistent with an embodiment of the present invention. In step 1001, the quantity tables linked to a business object type are determined. For each of the quantity tables linked to the business object type determined in step 1001, a data item is read in step 1002. Once all the data items have been read, a data item is selected in step 1003. The selected data item is then included in the calculation.

The quantity tables linked to a business object type in step 1001 may be determined by finding quantity tables having a matching business key as is shown in FIG. 5. Alternatively, a configuration table, such as that shown in FIG. 7 containing links between object types 701 and quantity tables 702, may be interrogated. Consistent with another embodiment of the present invention, the method further includes interrogation of configuration table 700 and the use of the linked quantity tables, if any are listed, with the business key being examined and used to determine linked quantity table if there is no entry on configuration table 700 for a particular business object type.

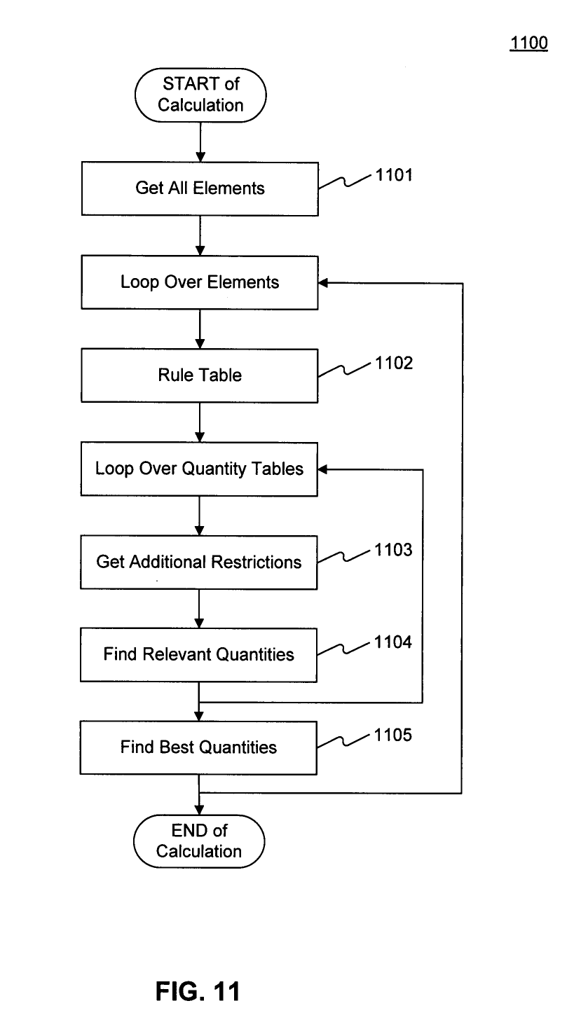

FIG. 11 is a flowchart of an exemplary method of performing a calculation, consistent with an embodiment of the present invention. In step 1101, the elements on which the calculation is performed are determined. For each element, the following steps are then carried out. A rule table is checked in step 1102 to determine if any rules restricting the quantity tables that can be used for determining data sources for inclusion in the calculation exist. For each quantity table, it is then determined whether any additional restrictions exist in step 1103. Relevant quantities are then found in step 1104. In step 1105, the best quantities for inclusion in the calculation are found. The process is repeated for every element so that the best quantities for inclusion in the calculation for each element are found and then the calculation is carried out.

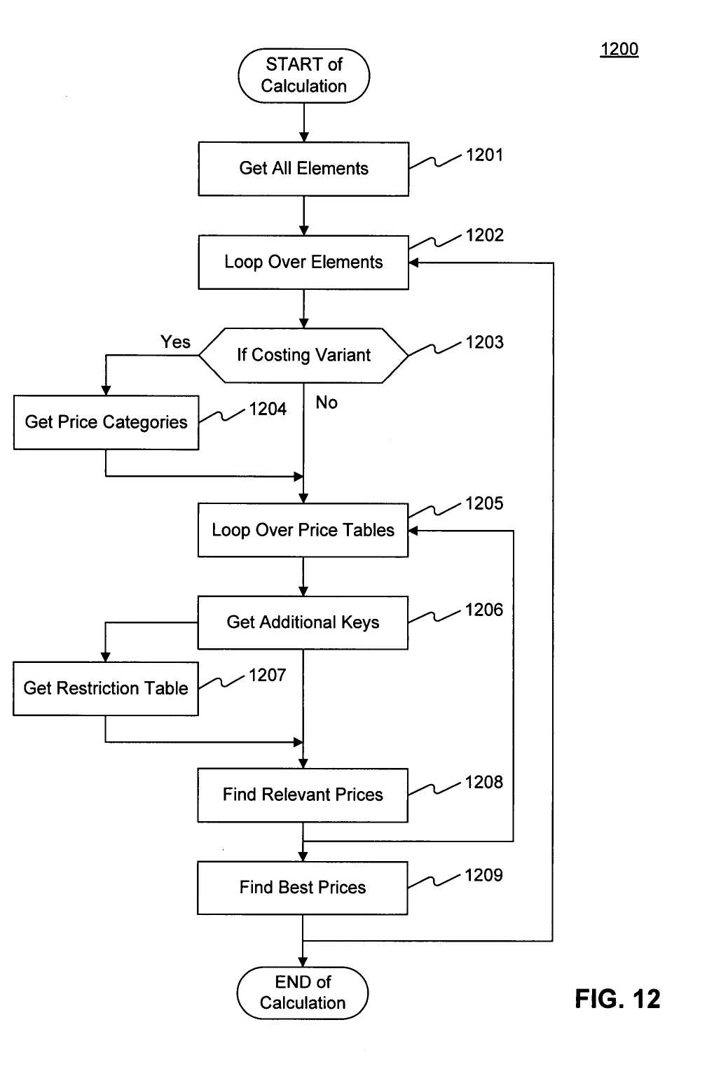

FIG. 12 is a flowchart of an exemplary method of preparing a quote, consistent with an embodiment of the present invention. In step 1201, all elements for the quote are determined. This may be from a business object for a cost estimate containing links to business objects for activities and materials required to deliver the quote. Once the elements required for the quote are determined, the elements are looped over starting from step 1202. In step 1203, it is determined whether a costing variant exists for the element. A costing variant is analogous to a rule table 609, examples of which are shown in FIGS. 8 and 9. A costing variant such as that in rule table 800 contains a number of price rules 801 which specify price categories. These can be used to determine which prices may be included in the quote. For example, for a given material, certain prices, such as those coming from stock rather than from a contract, may be preferred. The presence of the costing variant allows the user to configure which prices can be included in the quote. The price categories are determined in step 1204. This allows relevant price tables to be determined in step 1205. The price tables may be determined from the configuration table such as that shown in FIG. 7 or alternatively the price tables may be determined from matching business keys as shown in FIG. 5. Another alternative would be to check configuration table 700 for price tables for a given object type such as material and if no price tables were listed for a given object type then to search using business keys as shown in FIG. 5. In step 1206, it is determined whether additional keys exist in the price tables because these may apply if an additional restriction table exists. In step 1207, the restriction table is retrieved. The restriction table may contain further restrictions, for example, on allowed vendors. In step 1208, relevant prices are found. Then in step 1209, the best prices are determined from the relevant prices. The best prices are used in the calculation of the quote.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. Further, computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A data processing system for coupling business objects to data sources in a service oriented architecture, the business objects having a business object type from a plurality of business object types, and the data sources stored in quantity tables, each quantity table linked to a business object type, the system comprising:
a storage for storing a plurality of quantity tables;
first processing means for performing a calculation on at least a specified business object type from the plurality of business object types;
second processing means for determining a first group of quantity tables, the first group of quantity tables being the quantity tables linked to the specified business object type; and
third processing means for selecting a data source from a first group of data sources, the first group of data sources being the data sources stored in the first group of quantity tables,
wherein the first processing means uses the selected data source in the calculation.

2. The system of claim 1, wherein:
each business object has a plurality of business keys which uniquely identify the business object type of the business object, and the quantity tables are linked with a business object of a particular business object type having business keys that match the business keys of the business object of the particular business object type; and
the second processing means compares business keys of the specified business object with business keys of the quantity tables, and determines the first group of quantity tables as the quantity tables having business keys that match those of the specified business object type.

3. The system of claim 1, further comprising:
a storage for storing a configuration table defining links between business object types and quantity tables,
wherein the second processing means determines the first group of quantity tables by reading the configuration table.

4. The system of claim 1, further comprising:
a storage for storing at least one rule table containing restrictions on data sources to be used in the calculation, wherein
the second processing means further determines a second group of quantity tables, the second group of quantity tables being quantity tables in the first group of quantity tables that match the restrictions specified in the at least one rule table; and
the third processing means further selects a data source from a second group of data sources, the second group of data sources being the data sources stored in the second group of quantity tables.

5. The system of claim 4, wherein:
the at least one rule table comprises the identifier of a restriction table, the restriction table comprising restrictions on the data sources to be used in the calculation; and
the second processing means further determines the second group of quantity tables as quantify tables that match the restrictions specified in the at least one rule table and the restriction table.

6. A method of selecting a data source for coupling to a business object for inclusion in a calculation, the business object having a business object type from a plurality of business object types, the method comprising:
determining a first group of quantity tables, the first group of quantity tables being quantity tables linked to the business object type;
reading a first group of data sources, the first group of data sources comprising an item from each quantity table of the first group of quantity tables; and
selecting a data source from the first group of data sources for inclusion in the calculation.

7. The method of claim 6, wherein the business object has a plurality of business keys that uniquely identify the business object type of the business object, and the quantity tables are linked with a business object of a particular business object type having business keys that match the business keys of the business object of the particular business object type, the first group of quantity tables being quantity tables having business keys which match those of the business object.

8. The method of claim 6, further comprising reading a configuration table comprising links between business object types and quantity table types.

9. The method of claim 7, further comprising determining whether a configuration table contains a link for the business object type, the first group of quantity tables being determined from at least one of:
the configuration table if a link for the business object type exists, and
the business keys if a link for the business object type does not exist.

10. The method of claim 6, further comprising the steps of:
reading a rule table containing restrictions on the data sources for use in the calculation; and
determining a second group of data sources, the second group of data sources being data sources in the first group of data sources that match the restrictions in the rule table,
wherein the data source selected for inclusion in the calculation is selected from the second group of data sources.

11. The method of claim 10, wherein the rule table contains a plurality of rules which are applied in order of priority.

12. The method of claim 10, wherein the rule table contains an identifier of a restriction table comprising restrictions on the data sources for use in the calculation, and the second group of data sources being data sources that match the restriction table.

13. The method of claim 6, wherein the data source is a price.

14. The method of claim 13, wherein the calculation is for a preparation of a quote.

15. The method of claim 6, wherein the method is performed in a service oriented architecture.

16. A computer program product tangibly embodied in a computer-readable medium including computer executable instructions for performing the method of claim 6.
